(19) United States
(12) Patent Application Publication
(10) Pub. No.: US 2011/0225965 A1
(43) Pub. Date: Sep. 22, 2011

(54) WAVE ENERGY CONVERTOR

(75) Inventors: Johannes Lodewikus Van Niekerk, Stellenbosch (ZA); Gideon de Fallaux Retief, Somerset West (ZA)

(73) Assignee: STELLENBOSCH UNIVERSITY, Stellenbosch, Western Cape Province (ZA)

(21) Appl. No.: 13/132,206

(22) PCT Filed: Dec. 9, 2009
(86) PCT No.: PCT/IB09/07682

§ 371 Date: Jun. 1, 2011

(30) Foreign Application Priority Data
Dec. 10, 2008 (ZA) 2008/10446

(51) Int. Cl. F03B 13/18

(52) U.S. Cl. 60/497

(57) ABSTRACT

A wave energy convertor (1) is provided comprising an elongate construction (2), typically a breakwater or harbour wall, located in a body of water having wave action associated with it with the waves moving generally in a dominant wave direction (10) and having a generally constant wavelength. A plurality of equally spaced chambers (20) extends along the length of the construction internally thereof with each chamber extending generally upwardly and having at or near its lowermost end (28) an opening (24) into the body of water. Each chamber communicates through a unidirectional valve (40, 42) respectively with each of a high pressure conduit (44) and a low pressure conduit (46) with the high pressure conduit feeding into an inlet to a turbine (56) and the low pressure conduit communicating with an outlet from the turbine. The length of the construction is approximately equal to an integral number of said generally constant wavelengths in the dominant wave direction. The construction extends from a bed (4) of the body of water to above a high water level (8) with the opening of each chamber being located below a low water level (30) of the body of water.

### FIELD OF THE INVENTION

This invention relates to a wave energy convertor which is useful in converting energy from waves or swells in large bodies of water into electricity.

### BACKGROUND TO THE INVENTION

The conversion of wave energy into electricity has enjoyed much attention and many devices have been proposed for efficiently achieving this goal. One means of achieving this is to make use of the compressive effect that waves have on chambers of air connected to the body of water. With an advancing wave crest air in the chamber is forced out of an opening and used to drive a turbine which in turn drives a generator. As the wave trough arrives, air is drawn back into the chamber and can be used to similarly drive a turbine if drawn therethrough.

Most devices working on this principal employ what is referred to as an “oscillating water column” device. Thus, air is aspirated into and out of the chamber through a single opening with a turbine in flow communication with the opening. This results in the air flow oscillating in opposite directions in response to wave height increasing and decreasing. Consequently, air-flow through the turbine is reversed with each oscillation making the device fairly inefficient.

South African patent number 83/3976, which is incorporated in its entirety herein by reference, describes a generally off-shore, underwater wave energy convertor which also works on this principle but which aspirates a turbine through a separate inlet and outlet connected to a number of chambers. By connecting a number of such chambers together a closed air circuit may be formed with air flowing through the turbine in a single direction.

A full scale device as proposed in this patent has not yet been constructed, for one due to the high cost involved and the complexity of obtaining the required permission to construct such a device off-shore. The device also suffers from the disadvantage that, being designed to be completely submerged, the conduits to and from the turbine and all the associated valves have to be similarly submerged. To protect them from damage, it was proposed to incorporate these into the concrete body of elements making up the device. This makes the elements fairly complex to manufacture and also results in problems with leakage at joints. Still further, it is very difficult to maintain the conduits and valves underwater.

WO 2007/131289 discloses a floating device having a plurality of chambers connected in similar fashion to that described above. As it is a floating system it is dependent on the hydrodynamics of the floating body versus the prevailing wave climate. Also, its chambers each have an opening in the bottom and are thus only affected by potential energy variation and not kinetic energy. The disclosed device is similar to the Japanese Kaimei which was a converted tanker launched in the 1980's with a series of chambers open to the sea water under the hull of the ship. The Kaimei chambers were not interconnected by high and low pressure ducts as in this disclosure, and it suffered from wave length problems, like most floating devices.

The “French Bag” developed by Prof French in the 1980's was a submerged device working on the same concept but using elastic membranes instead of an enclosed water/air interface. However, Prof French used the same principle of interconnected high and low pressure ducts. This device too was never commercialised due to inherent problems.

### OBJECT OF THE INVENTION

It is an object of this invention to provide a wave energy convertor which will at least partially alleviate some of the abovementioned problems.

### SUMMARY OF THE INVENTION

In accordance with this invention there is provided a wave energy convertor comprising an elongate construction located in a body of water having wave action associated with it with the waves moving generally in a dominant wave direction and having a generally constant wavelength, a plurality of equally spaced chambers extending along the length of the construction internally thereof with each chamber extending generally upwardly and having below the waterline an opening into the body of water, and wherein each chamber communicates through a unidirectional valve with each of a high pressure conduit and a low pressure conduit with the high pressure conduit feeding into a turbine inlet and the low pressure conduit communicating with a turbine outlet, and wherein the length of the construction is approximately equal to an integral number of said generally constant wavelengths in the dominant wave direction, the wave energy convertor being characterized in that the construction extends from a bed of the body of water to above a high water level with the opening of each chamber being located below a low water level of the body of water.

Further features of the invention provide for the construction to be a fixed construction preferably of concrete or the like; for the construction to form a wave break or wall such as a harbour wall; for the opening of each chamber to face in the general direction of the oncoming waves; and for the high pressure conduit and low pressure conduit to be generally external of the construction and preferably above the construction.

Still further features of the invention provide for each chamber to communicate with the high pressure conduit and low pressure conduit through a single passage through the construction; alternatively separate passages through the body; and for the or each passage to open into the uppermost part of each chamber.

In order that the invention may be more fully understood one embodiment thereof will now be described with reference to the accompanying drawings.

### BRIEF DESCRIPTION OF THE DRAWINGS

In the drawings:

FIG. 1 is a part-sectional perspective view of a wave energy converter;

FIG. 2 is a part-sectional schematic illustration of the wave energy converter illustrated in FIG. 1;

FIG. 3 a top plan view of the wave energy converter illustrated in FIG. 1; and

FIG. 4 is a side elevation of the wave energy converter illustrated in FIG. 1.

### DETAILED DESCRIPTION WITH REFERENCE TO THE DRAWINGS

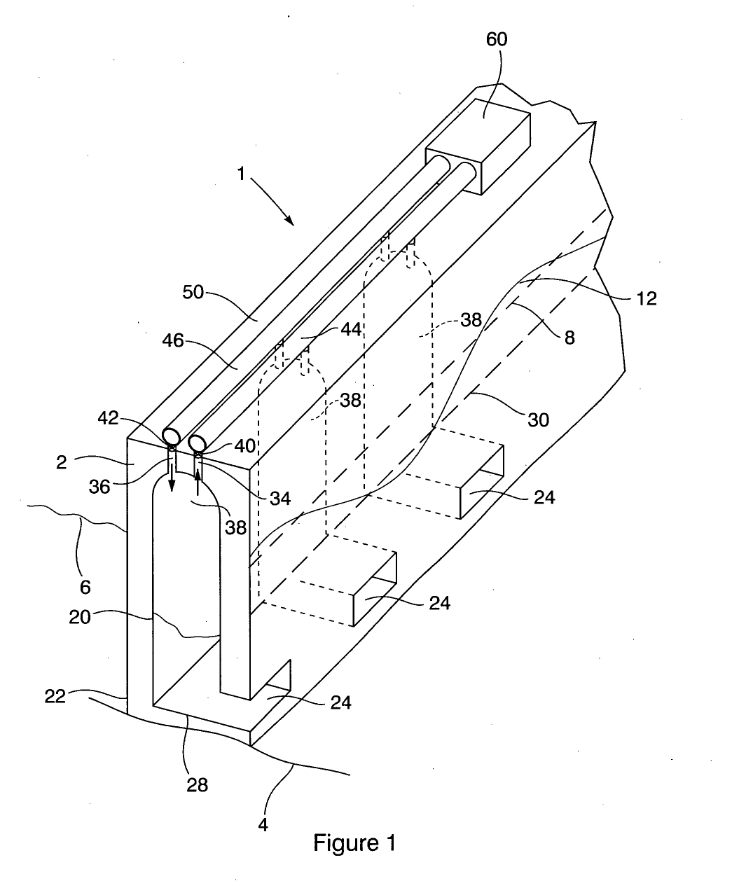

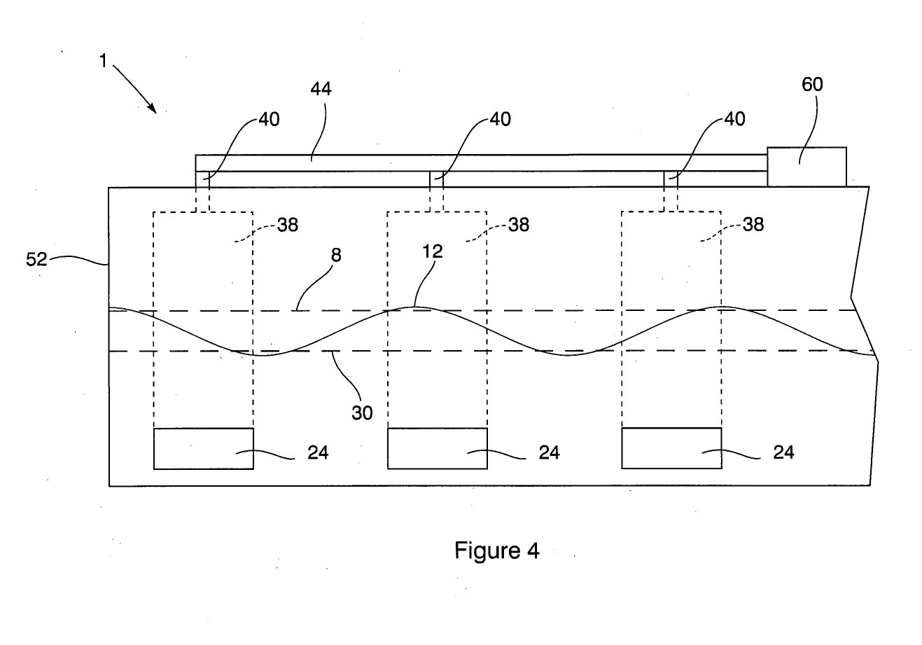

A wave energy converter (1) is shown in FIGS. 1 to 3 and includes an elongate construction (2), in this embodiment in the form of a concrete harbour wall or breakwater, which is located in the sea and extends from the sea bed (4) to above the surface (6) of the water, more particularly above the high water level (8) of the sea (indicated by broken lines in FIGS. 1 and 4).

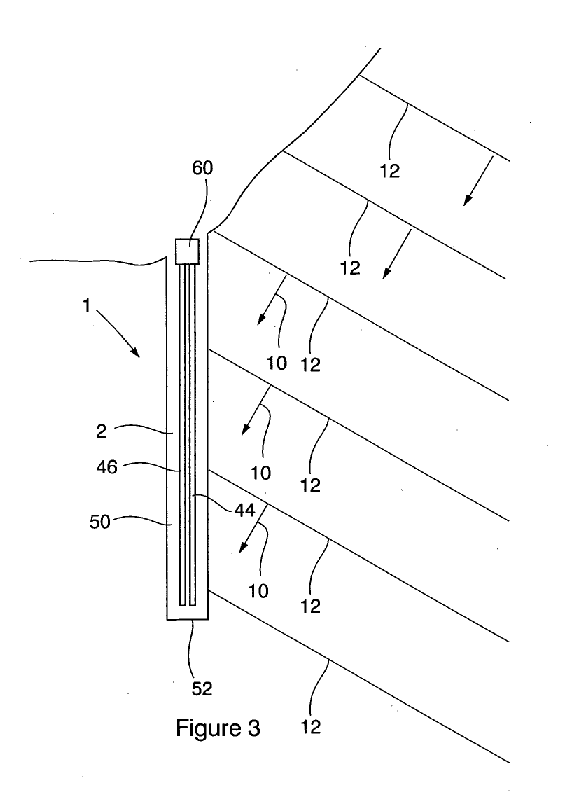

As shown more clearly in FIG. 3, the construction (2) is inclined to the dominant wave direction (10) of the waves (12) in that location with the length of the construction being at least one of said generally constant wavelengths, and preferably an integral number of said generally constant wavelengths in the dominant wave direction characteristic of the relevant locality. As the harbour wall is typically inclined to the dominant wave direction its length will be dependent on its angle of inclination to the dominant wave direction. The reason for this will become apparent from the further description below.

It is to be noted that the generally constant wavelength typically varies quite considerably according to geographical location, not direction in which the coastline extends, prevailing winds, and underwater topography to mention just some of the variables.

A series of independent chambers (20) are provided centrally along the length of the wall (2) equally spaced along its entire length. Each chamber (20) extends from near the bottom (22) of the wall (2) to near the top of the wall (2). A slot-like opening (24) is provided through the wall (2) on its side (26) facing the waves (12) into the lowermost end (28) of each chamber (20). The openings (24) are thus located below the low water mark (30) (indicated by broken lines).

A pair of passages (34, 36) extends through the wall (2) above each chamber (20) and opens into the uppermost part (38) of the respective chambers (20) at their lower end. At its upper end, each of the pair of passages (34, 36) is connected through a unidirectional valve (40, 42) to a high pressure conduit (44) and a low pressure conduit (46) respectively. The unidirectional valves (40) permit airflow out of each chamber (20) whilst each of the unidirectional valves (42) permits airflow into the respective chambers (20).

The high pressure conduit (44) and low pressure conduit (46) are, in this embodiment, pipes which run on the top (50) of the wall (2) and each is blind adjacent the outer end (52) of the wall (2). The opposite and inner end of the high pressure conduit (44) feeds into an inlet to a turbine (56) whilst that of the low pressure conduit (46) is connected to the outlet from the turbine (56). An electrical generator (58) is connected to the turbine (56) to be driven thereby and both are located in a housing (60).

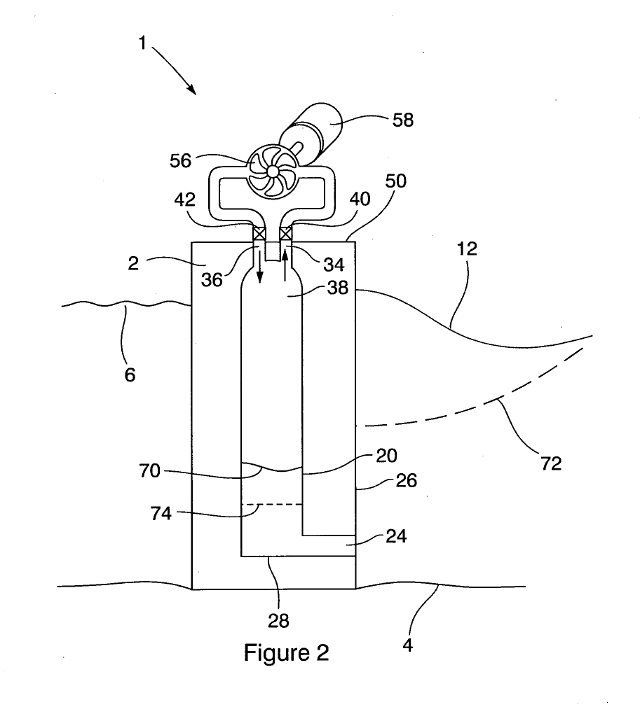

It will be appreciated that the chambers (20), high pressure conduit (44), low pressure conduit (46) and turbine (56) form a closed circuit with each of the chambers (20) acting as a pump to circulate air therethrough. As illustrated more clearly in FIG. 2, with the crest of a wave (12) adjacent to a chamber (20) the level of the water (70) therein increases with a consequent increase in the air pressure. This causes air in the chamber to be forced through the passage (34) and the unidirectional valve (40) into the high pressure conduit (44) and thence into the turbine (56).

As the trough of the wave (72) (indicated in broken lines) passes over the opening (24) to the chamber (20) the water level (74) in the chamber (20) drops causing air to be drawn into the chamber (20) through the passage (36) from the low pressure conduit (46). This action is repeated for each of the chambers sequentially.

Due to the orientation of the wall (2) in relation to the dominant wave direction (10), the waves (12) do not simultaneously activate all of the chambers (20) but rather cause them to operate sequentially as each wave moves along the length of the wall (2). As the length of wall in the dominant wave direction is an integral number of wavelengths with the chambers spaced within the wavelengths, certain of the chambers will be expelling air while others will be drawing air in. This has the effect of causing continuous operation of the turbine in a very effective manner.

Although the wave energy converter has a fixed orientation to the incident dominant wave direction it can be tuned to a wide range of wave lengths. In designing the construction, a selected, preferably predominant, wave pattern is used to determine a suitable generally constant wavelength on which to base the length of the body. Also, the chamber openings facing the incident waves permit higher conversion efficiency than a floating system with openings on the bottom as kinetic energy is harnessed in addition to the potential energy variations.

Being fixed on the sea bed permits easy connection to shore with a land based power plant. There is no need for ballast control, moorings or a floating power plan, and it is not affected by currents. In storm conditions, water can break over the construction, providing the wave energy converter with good survivability.

Furthermore, the wave energy converter has a predictable and easily controlled water level within the pumping chambers, with excess energy overtopping the breakwater. Prior art floating systems have a much more complex interaction between vessel motion, ballast settings and captured air which is not easy to manage.

The wave energy converter provides the further advantages of allowing easy access to the high pressure conduit and low pressure conduit, both of which can be located above water, as well as the turbine. Also, as the system provides a closed loop it is much more efficient than the conventional oscillating water column type arrangement.

It will be appreciated, however, that many other embodiments of wave energy converter exist which fall within the scope of the invention especially as regards the configuration thereof. For example, the body can have any suitable shape and could have a modular construction. Also, the chambers can have any suitable shape and configuration. For example, a single aspiration passage can be provided into each chamber and joined through a suitable T-connector and unidirectional valves to each of the high pressure conduit and low pressure conduit.

It will be appreciated that the high pressure and low pressure conduits could be incorporated into the concrete structure or they could be bitumen coated steel pipes or concrete pipes or made of any other suitable material. These conduits need not be mounted on the top of the breakwater where this area is needed for maintenance access. The conduits may be built into the caisson units, placed under a deck or even mounted on the harbour side of the breakwater. Also, the individual chambers can be simply secured adjacent to each other without the need for simultaneously connecting conduits running internally of the body.

1-9. (canceled)

10. A wave energy convertor comprising an elongate construction located in a body of water having wave action associated with it with the waves moving generally in a dominant wave direction and having a generally constant wavelength, a plurality of equally spaced chambers extending along the length of the construction internally thereof with each chamber extending generally upwardly and having at or near its lowermost end an opening into the body of water, and wherein each chamber communicates through a unidirectional valve with each of a high pressure conduit and a low pressure conduit with the high pressure conduit feeding into an inlet to a turbine and the low pressure conduit communicating with an outlet from the turbine, and wherein the length of the construction is approximately equal to an integral number of said generally constant wavelengths in the dominant wave direction, the wave energy convertor being characterized in that the construction extends from a bed of the body of water to above a high water level with the opening of each chamber being located below a low water level of the body of water.

11. A wave energy convertor as claimed in claim 10 in which the construction is a fixed construction of concrete or the like.

12. A wave energy convertor as claimed in claim 11 wherein the construction forms a wave break or wall.

13. A wave energy convertor as claimed in claim 10 wherein the opening of each chamber faces the oncoming wave side of the construction.

14. A wave energy convertor as claimed in claim 10 wherein the high pressure conduit and low pressure conduit are generally external of the construction.

15. A wave energy convertor as claimed in claim 10 wherein each chamber communicates with the high pressure conduit and low pressure conduit through a single passage through the construction.

16. A wave energy convertor as claimed in claim 15 wherein the passage opens into the uppermost part of each chamber.

17. A wave energy convertor as claimed in claim 10 wherein each chamber communicates with the high pressure conduit and low pressure conduit through separate passages through the construction.

18. A wave energy convertor as claimed in claim 17 wherein each passage opens into the uppermost part of each chamber.
